(19) United States
(12) Patent Application Publication
(10) Pub. No.: US 2009/0261963 A1
(43) Pub. Date: Oct. 22, 2009

(54) Vehicle Deceleration Warning System

(76) Inventor: Scott T. Ault, Reynolds, ND (US)

Correspondence Address: NEUSTEL LAW OFFICES, LTD., 2534 SOUTH UNIVERSITY DRIVE, SUITE 4, FARGO, ND, 58103, US

(21) Appl. No.: 12/237,986

(22) Filed: Sep. 25, 2008

Related U.S. Application Data
(63) Continuation-in-part of application No. 12/107,111, filed on Apr. 22, 2008.

(51) Int. Cl. B60Q 1/50

(52) U.S. Cl. 340/467

(57) ABSTRACT

A vehicle deceleration warning system for efficiently warning following vehicles of a decelerating or slow moving leading vehicle. The vehicle deceleration warning system generally includes an accelerometer, a control unit electrically connected to the accelerometer, a brake light relay electrically connected to the control unit and at least one brake light electrically connected to the brake light relay. The control unit activates the brake light relay to illuminate the at least one brake light depending upon a measurement taken by the accelerometer.

### CROSS REFERENCE TO RELATED APPLICATIONS

I hereby claim benefit under Title 35, United States Code, Section 120 of U.S. patent application Ser. No. 12/107,111 filed Apr. 22, 2008. This application is a continuation in-part of the Ser. No. 12/107,111 application. The Ser. No. 12/107,111 application is currently pending. The Ser. No. 12/107,111 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a vehicle deceleration warning system and more specifically it relates to a vehicle deceleration warning system for efficiently warning following vehicles of a decelerating or slow moving leading vehicle.

2. Description of the Related Art

Any discussion of the related art throughout the specification should in no way be considered as an admission that such related art is widely known or forms part of common general knowledge in the field.

Warning lights and indicators have been in use for years to alert following vehicle if a leading vehicle is engaging their brakes. The brake or warning lights are generally activated when the brake pedal or emergency brake is engaged. It is common for many individuals driving manual transmission vehicles to downshift when attempting to slow a vehicle rather than engaging the brake pedal.

Slowing a vehicle by downshifting generally utilizes engine compression to slow the vehicles. Downshifting can be an efficient manner in which to slow a vehicle and can drastically save on wear of vehicle brakes. Downshifting to slow a vehicle is also widely utilized by operators of commercial trucks or large vehicles to prevent their brakes from overheating or wearing significantly in that it generally takes more force to stop the commercial vehicles because of their large size.

When downshifting, because the brakes are not being engaged or utilized to slow the vehicle, the brake warning lights generally remain turned off. This can be very dangerous for following vehicles in that it may not be apparent that the leading vehicle is slowing down.

The reaction time by a following vehicle to notice that the leading vehicle is slowing down or moving at a slow pace is thus generally significantly lowered when a leading vehicle is slowing the vehicle by utilizing a downshifting technique. Because of the inherent problems with the related art, there is a need for a new and improved vehicle deceleration warning system for efficiently warning following vehicles of a decelerating or slow moving leading vehicle.

### BRIEF SUMMARY OF THE INVENTION

The general purpose of the present invention is to provide a vehicle deceleration warning system that has many of the advantages of the vehicle deceleration warning systems mentioned heretofore. The invention generally relates to an accelerometer, a control unit electrically connected to the accelerometer, a brake light relay electrically connected to the control unit and at least one brake light electrically connected to the brake light relay. The control unit activates the brake light relay to illuminate the at least one brake light depending upon a measurement taken by the accelerometer.

In the preferred embodiment, the vehicle speed is first measured, then the measured speed is compared to a speed threshold to determine if the current speed is below the speed threshold. If the speed is below the speed threshold the brake lights are illuminated. If the speed is above the speed threshold, the deceleration rate of the vehicle is measured. If the deceleration rate exceeds the deceleration threshold, the brake lights are illuminated. If not, the process is repeated, wherein if the brake lights were previously turned on, the brake lights are now turned off. The process of checking for the speed threshold and the deceleration threshold is continually repeated at timed intervals as long as the engine is running.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a vehicle deceleration warning system for efficiently warning following vehicles of a decelerating or slow moving leading vehicle.

Another object is to provide a vehicle deceleration warning system that may be installed separately than and in addition to a standard vehicle brake illumination system.

An additional object is to provide a vehicle deceleration warning system that may be installed on any type of vehicle.

A further object is to provide a vehicle deceleration warning system that includes indicator lights to alert the operator of the vehicle if the brake lights are on from exceeding the speed threshold or the deceleration threshold.

Another object is to provide a vehicle deceleration warning system that operates independently of the vehicle brakes.

Another object is to provide a vehicle deceleration warning system illuminates the brake lights if the vehicle is decelerating at a rate faster than a preset deceleration rate via downshifting, etc.

Another object is to provide a vehicle deceleration warning system illuminates the brake lights if the vehicle is moving at a slower pace (even if the vehicle is accelerating) than a preset speed threshold.

Another object is to provide a vehicle deceleration warning system that operates automatically so that an operator of the vehicle does not need to alter any driving habits to utilize the present invention.

An additional object is to provide a vehicle deceleration warning system that measures the deceleration of a vehicle using an accelerometer.

An additional object is to provide a vehicle deceleration warning system that activates the brake lights if the measured g-forces reach a certain threshold.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a flowchart illustrating the process of the present invention.

FIG. 2 is a block diagram illustrating the connection of the present invention with respect to a standard vehicle brake illumination system.

FIG. 3 is a block diagram illustrating the major components of the present invention.

FIG. 4 is a flowchart illustrating a sample process of the speed threshold being utilized to activate the brake lights.

FIG. 5 is a flowchart illustrating a sample process of the deceleration threshold being utilized to activate the brake lights.

FIG. 6 is a block diagram illustrating the new embodiment of the present invention.

### DETAILED DESCRIPTION OF THE INVENTION

### A. Overview

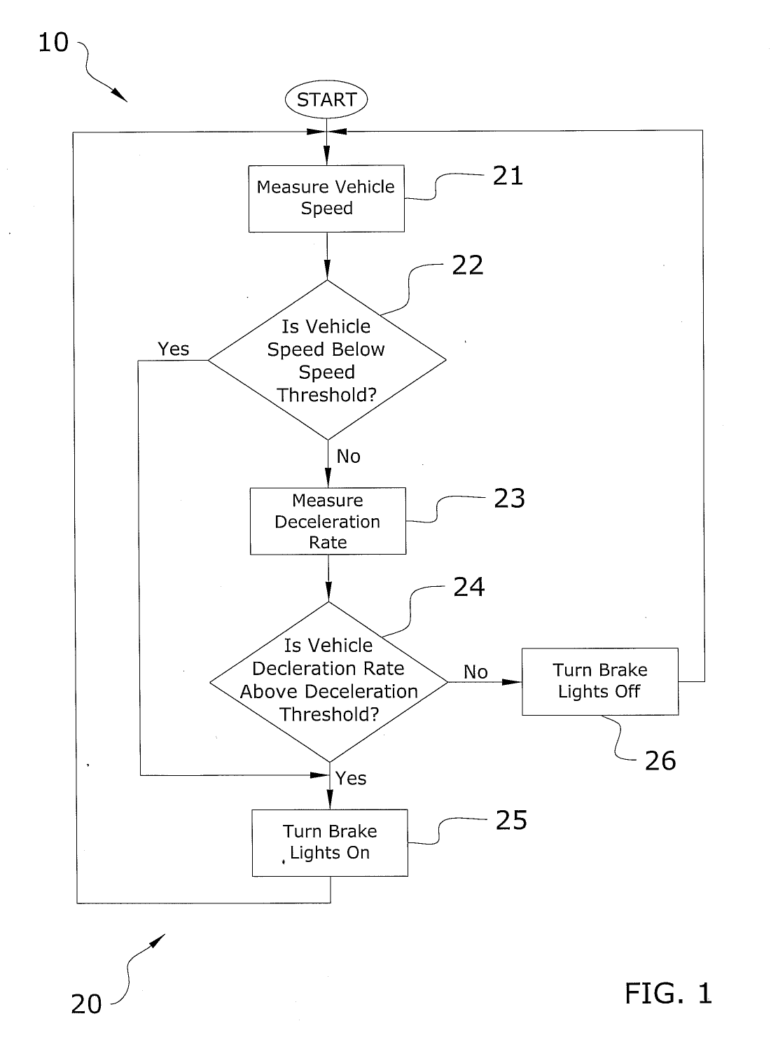

Turning now descriptively to the drawings, in which similar reference characters denote similar elements throughout the several views, FIGS. 1 through 6 illustrate a vehicle deceleration warning system 10, which comprises a speed sensor 14 and/or an accelerometer 19, a control unit 15 electrically connected to the speed sensor 14 and/or an accelerometer 19, a brake light relay 16 electrically connected to the control unit 15 and at least one brake light 13 electrically connected to the brake light relay 16. The control unit 15 activates the brake light relay 16 to illuminate the at least one brake light 13 depending upon a measurement taken by the speed sensor 14 and/or an accelerometer 19.

In the preferred embodiment of the driving process 20 as illustrated in FIG. 1, the vehicle speed is first measured as in step 21, then the measured speed is compared to a speed threshold to determine if the current speed is below the speed threshold as in step 22. If the speed is below the speed threshold the brake lights 13 are illuminated as in step 25. If the speed is above the speed threshold, the deceleration rate of the vehicle is measured as in step 23.

The deceleration rate is compared to a deceleration threshold (which may be measured in miles per hour, gravitational force or other means of determining a vehicle's deceleration) to determine if the deceleration rate exceeds the deceleration threshold as in step 24. If the deceleration rate exceeds the deceleration threshold, the brake lights 13 are illuminated as in step 25. If not, the process is repeated, wherein if the brake lights 13 were previously turned on, the brake lights 13 are now turned off as in step 26. The process of checking for the speed threshold and the deceleration threshold is continually repeated at timed intervals as long as the engine is running.

### B. Setup

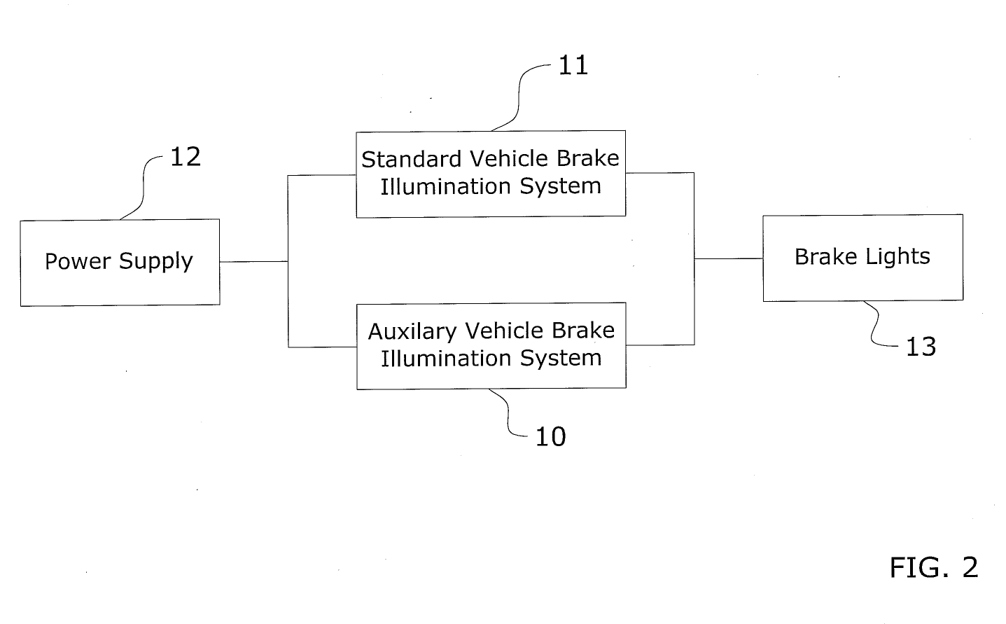

The present invention is preferably installed as an auxiliary vehicle brake illumination system 10 on a standard vehicle (e.g. automobile, tractor-trailer, semi-truck, snow mobile, ATV, motorcycle, etc.) in addition to the standard vehicle brake illumination system 11. FIG. 2 illustrates the connection of the present invention 10 with respect to the standard vehicle brake illumination system 11, wherein the present invention 10 and the standard vehicle brake illumination system 11 are connected in a parallel configuration. The standard vehicle brake illumination system 11 as referred to in the present description is the components (i.e. electrical and mechanical) that activate the brake lights 13 of the vehicle. Such components include the brake pedal or emergency brake, such that when activated sends a signal to a relay or switch to turn on (i.e. illuminate) the brake lights 13.

The present invention also functions to utilize the standard brake lights 13 of the vehicle, only the present invention does not utilize the brakes of the vehicle to turn on the brake lights 13 and further is not activated by the brakes being utilized. The present invention serves to turn on the brake lights 13 when a vehicle is moving at a slow pace or decelerating quickly. The present invention is especially useful for commercial truck (e.g. semi-truck, etc.) drivers who frequently downshift to slow their vehicle rather than applying the brakes (i.e. standard vehicle brake illumination system 11). The present invention thus allows the brake lights 13 of the vehicle to turn on when decelerating via downshifting even if the brakes are not being applied.

It is appreciated however that the present invention may be utilized on various of other types of vehicles rather than commercial trucks. It is also appreciated that the present invention may utilize the standard vehicle power supply 12 (i.e. 12 volt battery) along with the standard vehicle brake illumination system 11 or the present invention may include an alternate power supply 12.

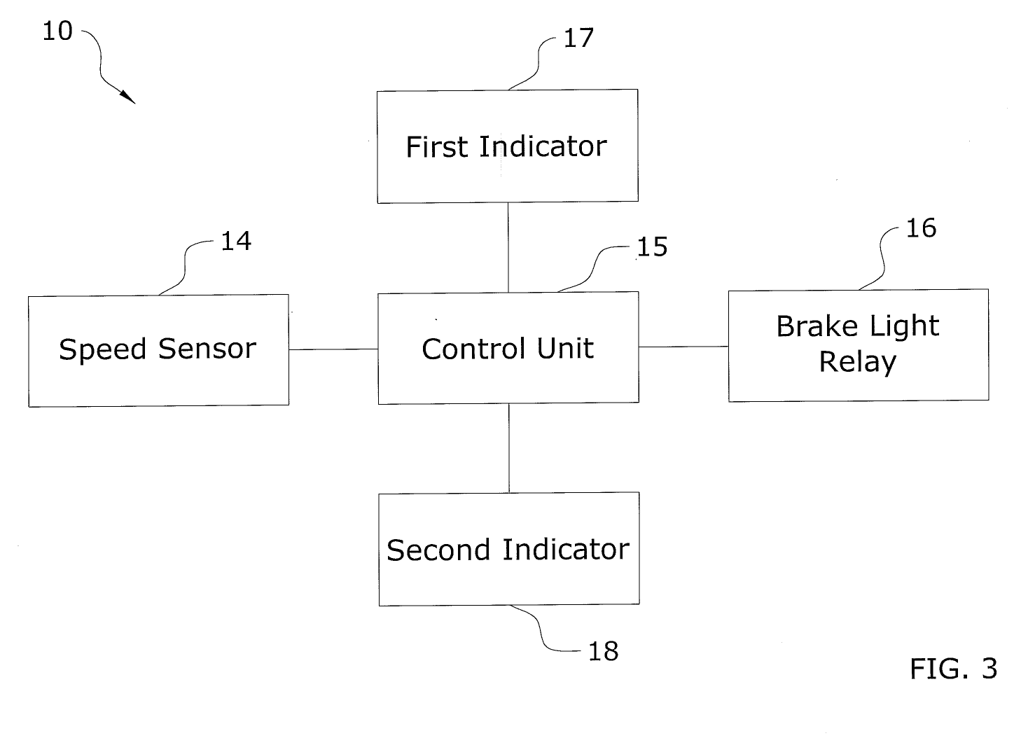

FIG. 3 illustrates a possible embodiment of the present invention as referred to in the auxiliary vehicle brake illumination system 10 of FIG. 2. The present invention includes a speed sensor 14 to detect the speed for the speed threshold and the deceleration threshold, a control unit 15 electrically connected to the speed sensor 14, a brake light relay 16 electrically connected to the control unit 15 opposite the speed sensor 14 and a pair of indicators electrically connected in parallel to the control unit 15. It is appreciated that the present invention naturally includes various other electrical and mechanical components (e.g. fuses, etc.) to allow the present invention to operate.

The speed sensor 14 may be comprised of various types of sensors. The speed sensor 14 may be comprised of the standard speed sensor 14 already utilized upon the vehicle, wherein a separate connection is simply run from the preexisting speed sensor 14 to the control unit 15 for the present invention. It is also appreciated that the speed sensor 14 may be comprised of an auxiliary speed sensor 14, wherein the speed sensor 14 may be comprised of an ABS (anti-lock braking system) speed sensor 14, a USS type sensor, an auxiliary wheel speed sensor 14, a GPS (global positioning satellite) sensor, a gyro sensor.

It is appreciated that a GPS sensor and a gyro sensor may not be as efficient and cost effective as utilizing the standard vehicle speed sensor 14 or an auxiliary speed sensor 14, such as a wheel sensor or an ABS speed sensor 14. It is also appreciated that in various alternate embodiments of the present invention, the present invention may include multiple speed sensors 14.

The control unit 15 is electrically connected to the speed sensor 14. The control unit 15 receives the speed recording of the speed sensor 14 to determine whether the brake lights 13 should turn on. The control unit 15 is preferably comprised of a control module and may be separately installed upon a standard vehicle. The control unit 15 and present invention also preferably only operate when the vehicle ignition is turned to an on position and the engine is started.

The control unit 15 also is programmed to include a deceleration algorithm to calculate the rate of deceleration that is needed to activate the brake lights 13. The deceleration algorithm preferably measures the speed or speed ratio against a selected frequency to determine the deceleration rate. The control unit 15 may also be programmed to a desired speed threshold or deceleration threshold depending upon the desired application. However, it is appreciated that the speed threshold and the deceleration threshold may be standard upon vehicles that are utilized upon public roads. An example embodiment of the present invention includes a speed threshold of 10 miles per hour and a deceleration threshold of approximately ⅓ miles per hour per half second.

In the new embodiment, the control unit 15 may be comprised of an integrated circuit to receive data from an accelerometer 19 so as to compare a currently measured g-force reading of the vehicle to a g-force threshold. It is appreciated that the control unit 15 may be directly connected to the brake lights 13, wherein when the g-force measured by the accelerometer 19 is beyond the threshold, the control unit 15 directly turns on the brake lights 13.

The brake light relay 16 is electrically connected to the control unit 15. The brake light relay 16 receives a signal from the control unit 15 to determine whether the brake lights 13 should turn on. The brake light relay 16 is preferably comprised of a relay or switch and may be separately installed upon a standard vehicle. The brake light relay 16 may be comprised of various types of relays. The brake light relay 16 may be comprised of the standard brake light relay 16 already utilized upon the vehicle, wherein a separate connection is simply ran from the preexisting brake light relay 16 to the control unit 15 for the present invention.

It is also appreciated that the brake light relay 16 may be comprised of an auxiliary brake light relay 16. In the preferred embodiment when the deceleration threshold is exceeded or the vehicle speed is below the speed threshold the brake light relay 16 is tripped thus causing the brake lights 13 to turn on. The brake light relay 16 subsequently is reset when the deceleration threshold has not been met and the vehicle speed exceeds the speed threshold.

The present invention also includes the first indicator 17 and the second indicator 18. The first indicator 17 and the second indicator 18 may alert the operator that the brake lights 13 are on in various manners, such as audible, tangible, or visible alerts. In the preferred embodiment, the first indicator 17 and the second indicator 18 alert the driver via a visible alert. The first indicator 17 and the second indicator 18 are preferably located within the cab of the vehicle and may be positioned upon the dashboard within the cab for easy viewing of by the operator of the vehicle. The first indicator 17 and the second indicator 18 preferably separably illuminate depending upon which threshold (speed or deceleration) is currently activating the brake lights 13.

In one embodiment, when the speed threshold has not been met, the first indicator 17 illuminates, thus alerting the operator of the vehicle that the brake lights 13 are on and the vehicle speed is below the speed threshold. If the deceleration threshold has been met, the second indicator 18 illuminates, thus alerting the operating of the vehicle that the brake lights 13 are on and the deceleration threshold has been met.

It is appreciated that the first indicator 17 and the second indicator 18 may illuminate in various colors (e.g. yellow, red, etc.), wherein the first indicator 17 and the second indicator 18 preferably illuminate in different colors so as to not cause confusion upon the operator of the vehicle. It is also appreciated that the first indicator 17 and the second indicator 18 are electrically connected in a parallel configuration to the control unit 15.

The new embodiment preferably utilizes an accelerometer 19 to measure the gravitational force (i.e. g-force) of the vehicle. It is appreciated that the vehicle may include more than one accelerometer 19 and the accelerometers 19 may be positioned at various places upon the vehicle in which to take an accruement measurement. It is appreciated that the accelerometer 19 may measure the gravitational force continually or at predefined intervals. The new embodiment accelerometer 19 may also be connected to the indicators 17, 18 to activate the indicators 17, 18 in a similar manner as the speed sensor 14. It is also appreciated that various embodiments of the present invention may be combined as desired or needed.

### C. Speed Threshold Process

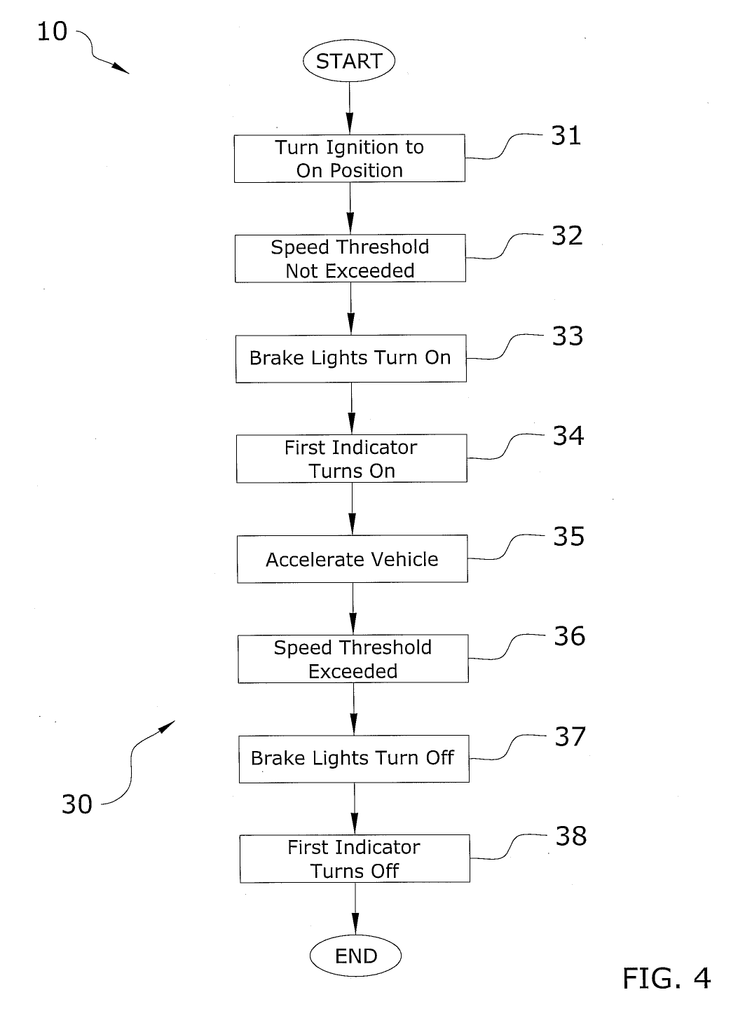

FIG. 4 illustrates the process of the brake lights 13 being activated (i.e. turned on) via the vehicle speed not meeting the speed threshold (i.e. speed threshold process 30). It is appreciated that FIG. 4 is merely illustrative of a possible process of the speed threshold coming into play and even though FIG. 4 includes an “End” junction, the process of checking to see if the speed threshold is met is continuous as long as the vehicle engine is running. It is also appreciated that even though the speed threshold process 30 is illustrated separably as the deceleration threshold process 40, both processes 30, 40 are continuously being checked in a simultaneous manner upon vehicles including the present invention.

Step 31 illustrates that the vehicle engine must be turned on and the ignition turned to the on position for the control unit 15 to check if the speed threshold has been met. Step 32 illustrates the speed threshold not being met, wherein the vehicle is traveling at a slower pace than the speed threshold. When the vehicle is moving at a slower pace than the speed threshold, the brake lights 13 turn on as illustrated in step 33. When the brake lights 13 turn on because the speed threshold has not been met, the first indicator 17 turns on as in step 34 to alert the operator of the vehicle that the brake lights 13 are illuminated.

As the vehicle is accelerated as in step 35 and the speed threshold is exceeded (i.e. vehicle traveling faster than speed threshold) as in step 36, the brake lights 13 are deactivated and thus turn off as in step 37. It is appreciated that when the brake lights 13 turn off, the first indicator 17 subsequently turns off as in step 38. It is appreciated that if the vehicle subsequently slows down to a pace slower than the speed threshold, the brake lights 13 and the first indicator 17 will once again illuminate.

### D. Deceleration Threshold Process

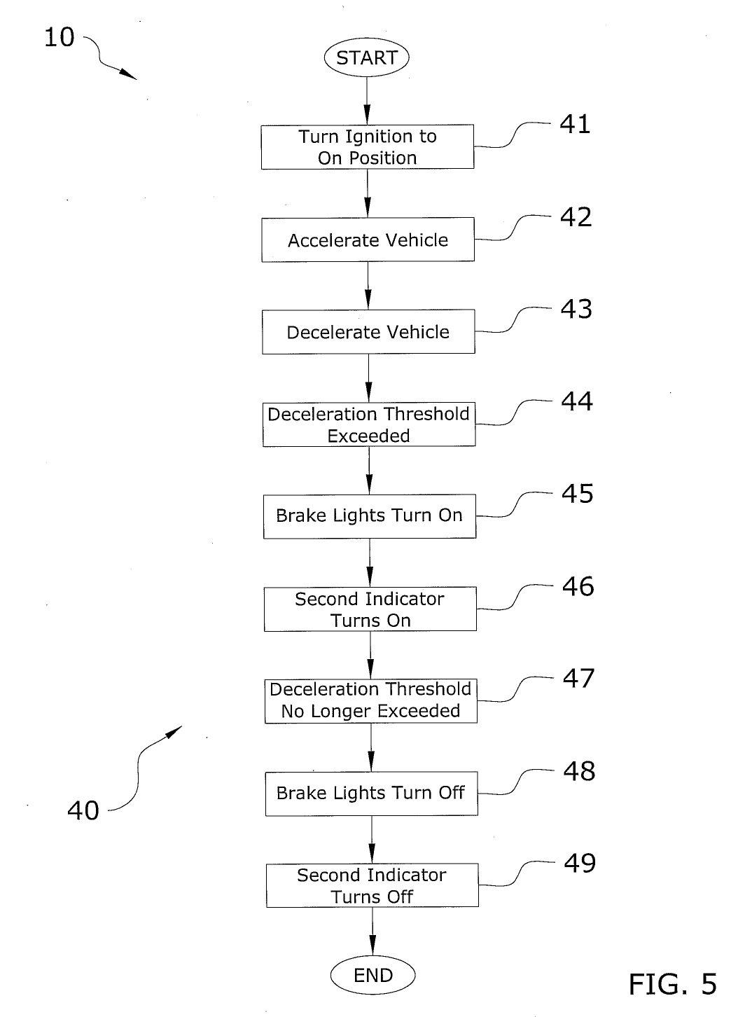

FIG. 5 illustrates the process of the brake lights 13 being activated (i.e. turned on) via the vehicle deceleration meeting the deceleration threshold (i.e. deceleration threshold process 40). It is appreciated that FIG. 5 is merely illustrative of a possible process of the deceleration threshold coming into play and even though FIG. 5 includes an “End” junction, the process of checking to see if the deceleration threshold is met is continuous as long as the vehicle engine is running. It is also appreciated that even though the deceleration threshold process 40 is illustrated separably as the speed threshold process 30, both processes 30, 40 are continuously being checked in a simultaneous manner upon vehicles including the present invention.

Step 41 illustrates that the vehicle engine must be turned on and the ignition turned to the on position for the control unit 15 to check if the deceleration threshold has been met. It is appreciated that although the speed threshold process is not illustrated in FIG. 5, the speed threshold process will inherently be utilized in FIG. 5 in that the vehicle is not automatically moving at a speed greater than the speed threshold when the engine is turned on.

Step 42 illustrates the vehicle accelerating or moving at a steady pace. Step 43 illustrates the vehicle decelerating. It is appreciated that the vehicle may be decelerating for various reasons, such as coasting, downshifting, climbing a hill, and various others. Step 44 illustrates the deceleration threshold being met because the vehicle is decelerating a pace faster than what the decelerating threshold set at. It is appreciated that the deceleration rate of the deceleration is calculated utilizing the deceleration algorithm. Step 44 in the new embodiment is where the currently measured g-forces have exceeded the g-force threshold.

The deceleration algorithm measures the rate at which the vehicle is slowing by a first speed at a first time and a next speed at a next time, wherein a preset interval is determined for measuring at the first time and the next time. The deceleration algorithm then takes the ratio of the two speeds measured against the time interval to determine the deceleration rate. This deceleration rate is measured against the predetermined deceleration threshold to determine if the vehicle is slowing at a pace greater than the deceleration threshold. It is appreciated that the deceleration threshold is preferably set at a rate that will prevent the brake lights 13 from coming on during normal coasting, wherein the brake lights 13 are preferably activated when downshifting the vehicle to slow the vehicle.

When the vehicle is decelerating at a faster rate than the deceleration threshold, the brake lights 13 turn on as illustrated in step 45. When the brake lights 13 turn on because the deceleration threshold has been met, the second indicator 18 turns on as in step 46 to alert the operator of the vehicle that the brake lights 13 are illuminated. As the vehicle speeds up or the deceleration rate slows to a pace less than the deceleration threshold as in step 47, the brake lights 13 are deactivated and thus turn off as in step 48. It is appreciated that when the brake lights 13 turn off, the second indicator 18 subsequently turns off as in step 49. It is appreciated that if the vehicle subsequently slows at a rate faster than the deceleration rate of the deceleration threshold, the brake lights 13 and the second indicator 18 will once again illuminate.

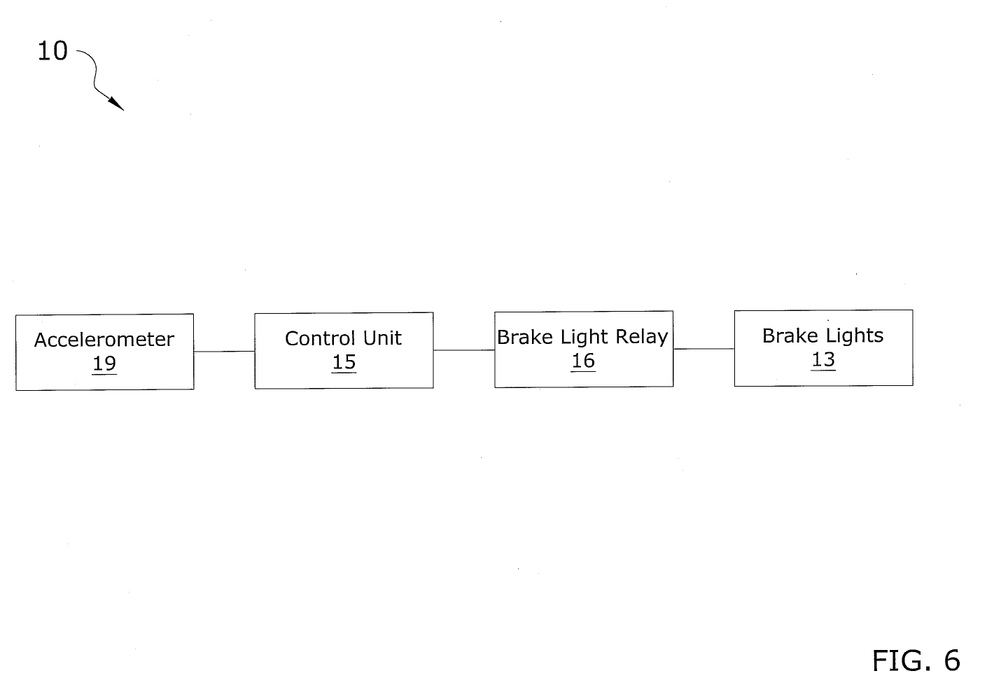

In the new embodiment the deceleration threshold is measured by an accelerometer 19. The accelerometer 19 is connected to the control unit 15, which in turn is connected to the brake light relay 16 as illustrated in FIG. 6. The accelerometer 19 measures the g-force of the vehicle at least as the vehicle is decelerating. When the g-force measured by the accelerometer 19 reaches a certain threshold, the control unit 15 signals to the brake light relay 16 to turn the brake lights 13 on. Likewise, when the threshold of the g-forces is not met or no longer met, the control unit 15 signals to the brake light relay 16 to turn the brake lights 13 off. The threshold preferably used to determine if the brake lights 13 are turned on or off is 0.8 g; however it is appreciated that other thresholds may be used depending on the desired application. The accelerometer 19 preferably takes continuous readings so as to constantly measure the deceleration or acceleration rate of the vehicle.

### E. Operation of New Embodiment

In use, when the engine is turned on, the brake lights 13 are automatically activated. As the vehicle is accelerated and the speed threshold is exceeded (i.e. vehicle traveling faster than speed threshold), the brake lights 13 are deactivated and thus turn off. When the vehicle slows down to a pace slower than the speed threshold, the brake lights 13 and the first indicator 17 will once again illuminate. This is determined by using the accelerometer 19 to measure the g-force of the vehicle. Once the g-force of the vehicle exceeds the pre-defined threshold, the brake lights 13 turn on. It is appreciated that the accelerometer 19 may be used in addition to or in place of the speed sensor 14.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. A method of providing a vehicle deceleration warning system, comprising:
measuring a deceleration rate of a vehicle with an accelerometer;
comparing said deceleration rate to a deceleration threshold;
determining if said deceleration rate exceeds said deceleration threshold; and
illuminating at least one brake light when said deceleration rate exceeds said deceleration threshold.

2. The method of providing a vehicle deceleration warning system of claim 1, wherein said at least one brake light is comprised of a standard vehicle brake light.

3. The method of providing a vehicle deceleration warning system of claim 1, including a step of turning off said at least one brake light when said deceleration rate is below said deceleration threshold.

4. The method of providing a vehicle deceleration warning system of claim 1, wherein said deceleration rate is determined by measuring a gravitational force.

5. The method of providing a vehicle deceleration warning system of claim 4, wherein said deceleration threshold is 0.8 g.

6. The method of providing a vehicle deceleration warning system of claim 1, including a step of activating an indicator when said deceleration rate exceeds said deceleration threshold.

7. The method of providing a vehicle deceleration warning system of claim 6, wherein said indicator illuminates when activated.

8. The method of providing a vehicle deceleration warning system of claim 6, wherein said indicator is positioned within a cab of said vehicle.

9. A method of providing a vehicle deceleration warning system, comprising:
measuring a current speed of a vehicle with a speed sensor;
comparing said current speed to a speed threshold;
determining if said current speed is below said speed threshold;
illuminating at least one brake light when said current speed is below said speed threshold;
accelerating said vehicle beyond said speed threshold;
decelerating said vehicle;
measuring a deceleration rate of said vehicle with an accelerometer;
comparing said deceleration rate to a deceleration threshold;
determining if said deceleration rate exceeds said deceleration threshold; and
illuminating said at least one brake light when said deceleration rate exceeds said deceleration threshold.

10. The method of providing a vehicle deceleration warning system of claim 9, wherein said at least one brake light is comprised of a standard vehicle brake light.

11. The method of providing a vehicle deceleration warning system of claim 9, including a step of turning off said at least one brake light when said deceleration rate is below said deceleration threshold and above said speed threshold.

12. The method of providing a vehicle deceleration warning system of claim 9, wherein said deceleration rate is determined by measuring a gravitational force.

13. The method of providing a vehicle deceleration warning system of claim 9, including a step of activating an indicator when said deceleration rate exceeds said deceleration threshold.

14. The method of providing a vehicle deceleration warning system of claim 13, wherein said indicator is positioned within a cab of said vehicle.

15. The method of providing a vehicle deceleration warning system of claim 9, including a step of activating an indicator when said current speed is below said speed threshold.

16. The method of providing a vehicle deceleration warning system of claim 15, wherein said indicator is positioned within a cab of said vehicle.

17. A vehicle deceleration warning system, comprising:
an accelerometer to measure a gravitational force of a vehicle;
a control unit electrically connected to said accelerometer;
at least one brake light relay electrically connected to said control unit; and
at least one brake light electrically connected to said brake light relay;
wherein said control unit activates said at least one brake light relay to illuminate said at least one brake light depending upon a measurement taken by said accelerometer.

18. The vehicle deceleration warning system of claim 17, wherein said at least one brake light is comprised of a standard vehicle brake light.

19. The vehicle deceleration warning system of claim 17, including at least one indicator to illuminate when said at least one brake light illuminates.

20. The vehicle deceleration warning system of claim 19, wherein said at least one indicator is positioned within a cab of said vehicle.
